(19) United States
(12) Patent Application Publication
(10) Pub. No.: US 2003/0192988 A1
(43) Pub. Date: Oct. 16, 2003

(54) Propulsion device with rotating elastic material

(76) Inventor: David Fitzgerald, Dayton, OH (US)

Correspondence Address: David Fitzgerald, 2432 D Wyoming St., Dayton, OH, 45410, US

(21) Appl. No.: 10/121,211

(22) Filed: Apr. 12, 2002

(51) Int. Cl. B64C 27/00; B64C 39/00

(52) U.S. Cl. 244/62

(57) ABSTRACT

A propulsion device which takes advantage of the fact that the mass of an object will decrease if the energy density of the object changes rapidly. The energy density is changed by causing rapid mechanical deformations of the object. By these means, the mass of a rotating object is decreased to one side of its axis of rotation, creating an unbalanced centrifugal force that acts on the rotating object as a propulsive force in the direction from the lower mass half toward the higher mass half. The propulsive force is used to propel an object or hold an object in position in opposition to an outside force or provide mechanical energy for a purpose such as the generation of electricity.

### CROSS REFERENCE TO RELATED APPLICATION

This invention operates by the same physical principle as co-pending application, Ser. No. 09/961,545, filed Sep. 22, 2001.

### BACKGROUND OF THE INVENTION

1. Field of the Invention

This invention relates generally to an apparatus for providing a propulsive force and more specifically to such an apparatus in which sections of a rotating object are caused to experience a mass decrease through part of the rotational period in order to create an imbalance of forces that results in propulsion.

2. Description of the Prior Art

Commonly used methods of propulsion rely on Newton's third law of motion. The third law of motion is often stated as: For every action there is an equal and opposite reaction. The principle can be seen in action as an aircraft moves forward by pushing air backward, as the tires of an automobile push the Earth in one direction causing the automobile to move in the opposite direction or as an exhaust of burnt propellant fired in a downward direction from a rocket engine sends a spacecraft upward.

The propulsion strategy of this invention is also based on the third law of motion but not through an interaction with nearby matter. Dr. James Woodward, in papers such as Rapid Spacetime Transport and Machian Mass Fluctuations: Theory and Experiment, published by the American Institute of Aeronautics and Astronautics as AIAA-2001-3908 has been able to show that it is possible to reduce the mass of an object by rapidly changing the energy density of that object. This induced mass decrease relies on the identity of inertia, as set forth in Mach's Principle, as being an effect of the gravitational force of all the matter in the universe acting on an object.

Dr. Woodward has experimentally achieved a mass decrease of approximately one percent in a specially designed group of piezoelectric elements that are quickly charged and discharged. The present invention makes use of this effect in a rotating object.

### OBJECTS AND ADVANTAGES

The objects and advantages of this invention are:

a. To provide a method of propulsion which does not include the forceful expulsion of an expendable reaction mass;

b. To provide a method of propulsion which does not require an interaction with nearby matter;

c. To provide a method of propulsion which will function in an atmosphere, underwater, or in a vacuum; and

d. To provide a method of propulsion which can be employed to generate electricity.

### SUMMARY OF THE INVENTION

The relevant equation shows that by rapidly changing the energy density of an object, the mass of the object will cycle between its base mass and a lower mass. The average of the object's mass over time would be less than the base mass of the object.

In this invention, mass fluctuation is caused to occur within elements of a rotating object. For the simplest embodiment, each particle of the rotating object will possess its base mass for half of each rotation, then for the other half of each rotation, a decreased time averaged mass is induced in each particle. For example, all particles of the rotating object could retain their base mass during the part of the rotation period when they are to the left of the axis of rotation. As each particle rotates into the area right of the axis, it is given a decreased average mass which is maintained until the particle once more rotates into the area left of the axis of rotation. This results in a propulsive force that would tend to move the rotating object in the direction of the greatest centrifugal force. Centrifugal force acts outward from the axis of the rotating object. Both halves of the rotating object have the same radial acceleration so the centrifugal force on the half of the rotating object having base mass will be greater than the centrifugal force on the half of the object having decreased mass. The propulsive force would be in the direction from the lower mass half to the higher mass half (to the left in the example above).

This invention changes the energy density of an object by causing compressive and tensile stress in the material of the object. Stress changes the length of chemical bonds that hold atoms together. In an elastic substance, energy is stored, changing the energy density, when an external force causes a change in bond length. This is reflected by a change in the mass density of the substance being stressed. It is important that both the amount of energy density change and the rate of energy density change are as high as possible.

This invention could propel any object. It could propel vehicles such as automobiles, boats, aircraft or spacecraft.

### BRIEF DESCRIPTION OF FIGURES

FIG. 1 shows an elastic cylinder and a substantially non-elastic cylinder.

FIG. 2 shows a rotating elastic cylinder in contact with a rotating, substantially non-elastic cylinder.

FIG. 3 is a top view of a large rotating elastic cylinder in contact with many smaller rotating cylinders.

FIG. 4 is a top view of a propulsion device with many rods that rapidly push into and pull out of a rotating elastic cylinder.

FIG. 5 is a top view of a rotating cylinder with many magnetic elements around its rim and an arc of magnetic segments.

FIG. 6 is a top view of a rotating cylinder with many pockets around its rim that contain an elastic material.

FIG. 7 shows a rotating disk positioned between two semicircular plates that contain electromagnets.

FIG. 8 shows a device for generating electricity in which two propulsion devices provide rotational motion to turn the shaft of an electric generator.

### REFERENCE NUMERALS IN DRAWINGS

| | |
|---|---|
| 9 elastic cylinder | 24 cylinder with pockets |
| 10 cylinder | 25 electromagnet |
| 11 shaft | 26 turntable |
| 12 second shaft | 27 electric generator shaft |
| 13 electric motor | 28 first propulsion device |
| 14 second electric motor | 29 second propulsion device |
| 15 small cylinder | 30 electric generator |
| 16 rod base | 31 arc |
| 17 rod | 32 magnetic cylinder |
| 18 magnetic element | 33 inner cylinder |
| 19 magnetic segment | 34 disk with magnetic particles |
| 20 pocket | 35 electric power source |
| 21 partition | 36 upper plate |
| 22 cap | 37 lower plate |
| 23 piezoelectric element | |

### DETAILED DESCRIPTION OF THE FIGURES

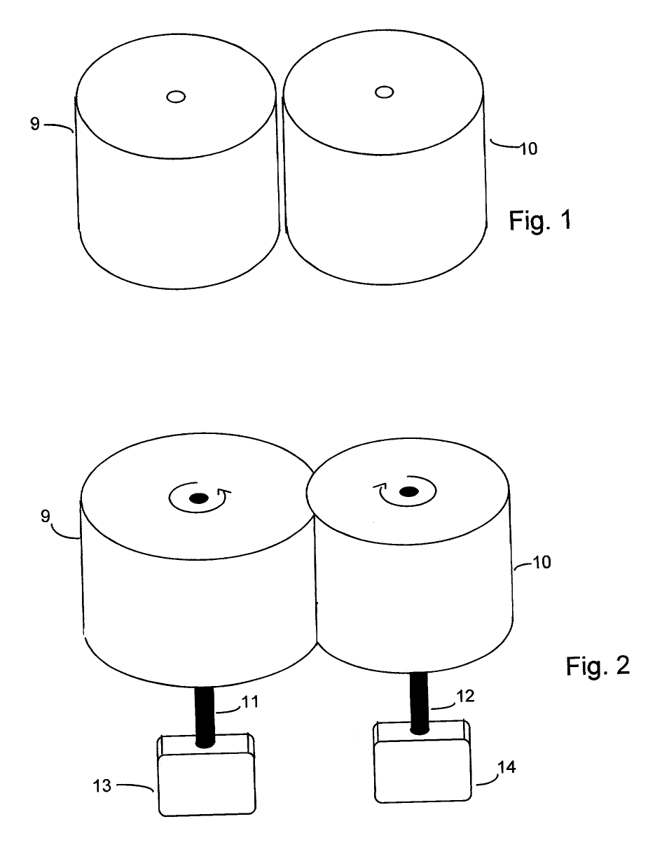

FIG. 1

In FIG. 1, two cylinders sit side by side. An elastic cylinder 9 is made of a material that deforms more easily under mechanical stress than the material of a cylinder 10. The material of elastic cylinder 9 should be elastic in nature so that it regains its original shape after mechanical stress is released.

FIG. 2

FIG. 2 shows elastic cylinder 9 attached to a shaft 11. Shaft 11 is caused to turn by an electric motor 13. Rotation of shaft 11 causes elastic cylinder 9 to rotate. Cylinder 10 is attached to a second shaft 12. Second shaft 12 is caused to turn by a second electric motor 14. Rotation of second shaft 12 causes cylinder 10 to rotate. Elastic cylinder 9 and cylinder 10 rotate rapidly. The circular arrows show that elastic cylinder 9 and cylinder 10 rotate in opposite directions. Elastic cylinder 9 is deformed by centrifugal force and expands to touch cylinder 10. To limit friction, the rate of rotation of each cylinder is gauged so that the rims of the two cylinders are moving at the same speed in the area where they touch.

The expansion of elastic cylinder 9 results in a decrease in its mass density. Material at the rim of elastic cylinder 9 feels a larger centrifugal force than material near the axis so the density is less near the rim, except in areas where elastic cylinder 9 and cylinder 10 are in contact. Throughout the area of contact, the density of that portion of elastic cylinder 9 is changing. The density at the rim of elastic cylinder 9 increases through the first half of the period of contact with cylinder 10 then decreases during the last half of the contact period. The quickly changing mass density shows that the energy density is also changing quickly, causing a time averaged decrease in the mass of elastic cylinder 9, in the area of contact with cylinder 10. This is the effect derived from Mach's principle that is described by Dr. James Woodward.

The mass to the left of the axis of elastic cylinder 9 in FIG. 2 is greater than the mass to the right of the axis. Because elastic cylinder 9 is rotating, a propulsive force will result from the changing mass in part of elastic cylinder 9. A greater centrifugal force will be felt on the left side of elastic cylinder 9 so there will be a propulsive force to the left.

Physical structures that are not shown connect electric motor 13 to second electric motor 14 so that the entire device shown in FIG. 2 would experience the propulsive force. The direction of the propulsive force can be altered by moving either elastic cylinder 9 or cylinder 10 relative to the other while keeping the two cylinders in contact.

It is assumed above that elastic cylinder 9 and cylinder 10 in FIG. 1 are close enough together that the expansion of elastic cylinder 9 due to centrifugal force would bring elastic cylinder 9 into contact with cylinder 10 as is shown in FIG. 2. Alternatively, if elastic cylinder 9 and cylinder 10 are not positioned close enough together for centrifugal force to bring the two cylinders into contact, a positioning mechanism that is not shown in FIGS. 1 or 2 could move elastic cylinder 9 and cylinder 10 into contact with each other.

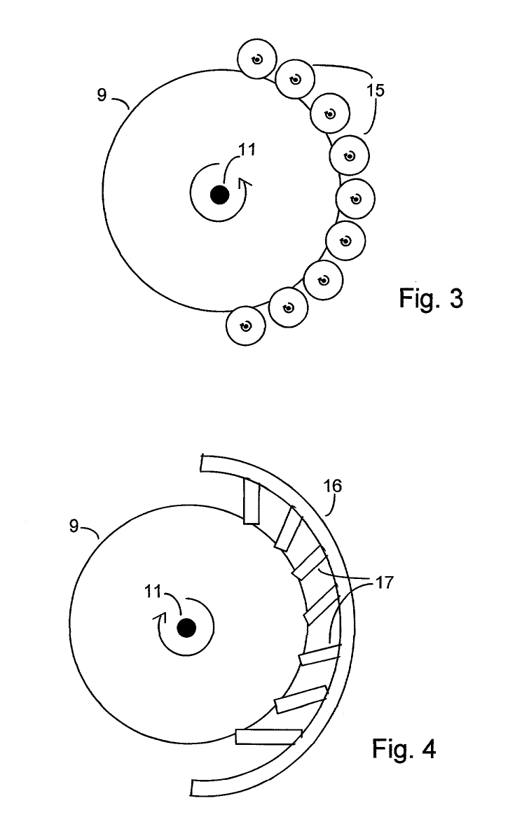

FIG. 3

FIG. 3 shows elastic cylinder 9 in contact with many examples of a small cylinder 15 that are not significantly deformable. Elastic cylinder 9 is attached to shaft 11. Shaft 11 is turning quickly and causes elastic cylinder 9 to rotate. Circular arrows show that small cylinders 15 are spinning in the opposite direction to elastic cylinder 9. Electric motors that cause the rotation of shaft 11 and small cylinders 15 are not shown. As the rim of elastic cylinder 9 passes through the area where it contacts small cylinders 15, the density of the rim rapidly changes. The mass of that portion of the rim of elastic cylinder 9 therefore decreases. As in FIG. 2, centrifugal force will cause a propulsive force directed from the lower mass half of elastic cylinder 9 toward the higher mass half (toward the left).

Elastic cylinder 9 and small cylinders 15 are linked together by physical structure that is not shown. Steering of the propulsive force is accomplished by moving the group of small cylinders 15 relative to elastic cylinder 9 while keeping elastic cylinder 9 in contact with small cylinders 15.

FIG. 4

FIG. 4 attempts to achieve the same results as in FIG. 3. Instead of many small cylinders, many examples of a rod 17 are connected to a rod base 16. Elastic cylinder 9 is attached to shaft 11, which is caused to turn by a motor that is not shown.

Rods 17 extend from rod base 16 to strike the surface of elastic cylinder 9, which is rapidly rotating, and cause a deformation. Rods 17 can be composed of any solid material and can be caused to strike elastic cylinder 9 by electromagnetic actuators, such as a solenoid or a motor, that are within rod base 16. Rods 17 could also be piezoelectric or piezoelectric in part. In which case, an electric field applied to rods 17 would cause rods 17 to elongate and strike elastic cylinder 9. An electric power source that powers the rotation of elastic cylinder 9 and the motion of rods 17 is not shown.

After making contact with and causing a deformation in elastic cylinder 9, rods 17 then retract away from the surface of elastic cylinder 9. To decrease friction on elastic cylinder 9, it is intended that rods 17 strike elastic cylinder 9 with a velocity component in the direction that elastic cylinder 9 is turning that is equal in magnitude to the velocity of the rim of elastic cylinder 9. As an additional means of decreasing friction, rods 17 are made to lift perpendicularly from the surface of elastic cylinder 9 by rod base 16 before retracting.

Rod base 16 and elastic cylinder 9 are linked together by physical structure that is not shown. Steering of the propulsive force is accomplished by moving rod base 16 relative to elastic cylinder 9 while keeping rod base 16 close enough to elastic cylinder 9 that rods 17 can make contact with elastic cylinder 9.

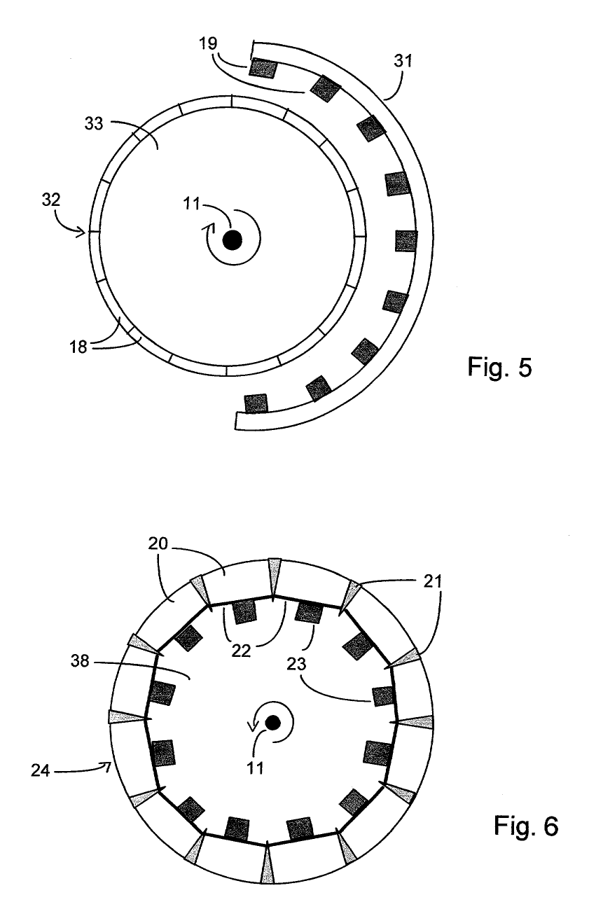

FIG. 5

FIG. 5 shows a magnetic cylinder 32, which is composed of an inner cylinder 33, made of an elastic material, with many examples of a magnetic element 18 affixed around the rim of inner cylinder 33. Magnetic cylinder 32 is attached to shaft 11. Many examples of a magnetic segment 19 are shown to the right of magnetic cylinder 32. Magnetic segments 19 are held in place relative to the position of magnetic cylinder 32 by an arc 31. Magnetic elements 18 and magnetic segments 19 can be permanent magnets or electromagnets.

An electric motor that is not shown turns shaft 11. Magnetic cylinder 32 is caused to rapidly rotate by shaft 11. A circular arrow indicates rotation of magnetic cylinder 32 but the direction of rotation is unimportant.

FIG. 5 represents several possible embodiments of a propulsion device that differ in the type of magnet used and the orientation of the poles of magnetic elements 18 and magnetic segments 19. In one embodiment, all magnets are permanent magnets and all magnetic elements 18 are oriented so that like poles (perhaps, all south) are on the outward face of magnetic cylinder 32. Magnetic segments 19 are oriented so that the poles facing magnetic cylinder 32 alternate north and south. As magnetic cylinder 32 rotates, magnetic elements 18 experience alternating push and pull forces as they turn past magnetic segments 19. Because magnetic elements 18 are physically attached to inner cylinder 33, the elastic material of inner cylinder 33 is compressed and stretched, causing rapid changes in energy density. There will therefore be a time averaged decrease in the mass of the portion of inner cylinder 33 that is facing magnetic segments 19 at any time during the rotation period. Magnetic cylinder 32 will experience a propulsive force in the direction opposite to the direction of magnetic segments 19. Arc 31 is physically attached by structure not shown to the motor that turns shaft 11 so all of FIG. 5 will be pulled to the left by the propulsive force.

A greater propulsive force can be achieved if magnetic segments 19 are electromagnets. As magnetic cylinder 32 rotates, a power source that is not shown causes each magnetic segment 19 to develop a magnetic field that rapidly changes, causing the rate of push and pull movement of magnetic elements 18 to increase. The higher rate of push and pull creates a faster change in energy density in the right side of inner cylinder 33 than if magnetic segments 19 were permanent magnets. The magnetic field produced by each magnetic segment 19 is made to change in both magnitude and direction so that the changes in the energy density of the right side of inner cylinder 33 can be as large and fast as possible. As, before, the change in energy density to the right of the center of inner cylinder 33 causes a propulsive force to the left.

Alternatively, magnetic elements 18 could be electromagnets that are caused to rapidly change the magnitude and direction of their magnetic field by an electric power source that is not shown. The changes to the magnetic fields of each magnetic element 18 would be made in conjunction with the magnetic fields of each magnetic segment 19 in order to make the changes in the energy density of the right side of inner cylinder 33 as large and as fast as possible.

FIG. 6

FIG. 6 shows a cylinder with pockets 24 that is rotating rapidly. The rim of cylinder with pockets 24 is composed of many examples of a pocket 20. Each pocket 20 is separated from the nearest other pocket 20 by a partition 21. Pockets 20 are filled with an elastic material. The material could be a solid. The material could also be a liquid or a gas. If a liquid or gas is used the top and bottom of each pocket 20 would be sealed by a wall that is not shown. A cap 22 that is attached to a piezoelectric element 23 makes up one wall of each pocket 20. A fill material 38 connects shaft 11 to caps 22 and piezoelectric elements 23. An electric motor that turns shaft 11 is not shown. Turning of shaft 11 causes cylinder with pockets 24 to rotate.

Electrical connections to piezoelectric elements 23 are not shown. When activated by an electric current, piezoelectric elements 23 cause caps 22 to move rapidly into and out of pockets 20, resulting in a periodic change in density of the elastic material. Rapid density changes cause the mass of the fluid to decrease. A propulsive force can be produced by activating only piezoelectric elements 23 in half of the rotating cylinder at any one time.

If the intended direction of travel is to the right, then piezoelectric elements 23 should be activated while they are to the left of a centerline. Elastic material to the right of the centerline would be more massive than elastic material to the left so centrifugal force would be greatest to the right, producing a propulsive force.

It should be noted that the surface area of each cap 22 is greater than the surface area of piezoelectric element 23 that is in contact with it. The difference in surface area means that the action of piezoelectric element 23 causes a greater change in the volume of elastic material in each pocket 20 than if the smaller surface of piezoelectric element 23 were in direct contact with the elastic material.

The distance that caps 22 move is very small. Instead of being free to move in pockets 20, each cap 22 could be a diaphragm, attached at the mouth of each pocket 20 that flexes in and out as piezoelectric element 23 moves it.

In an alternative embodiment, the movement of caps 22 caused by piezoelectric elements 23 could be achieved by other means. Caps 22 could be made to move by something such as a solenoid or an electric motor.

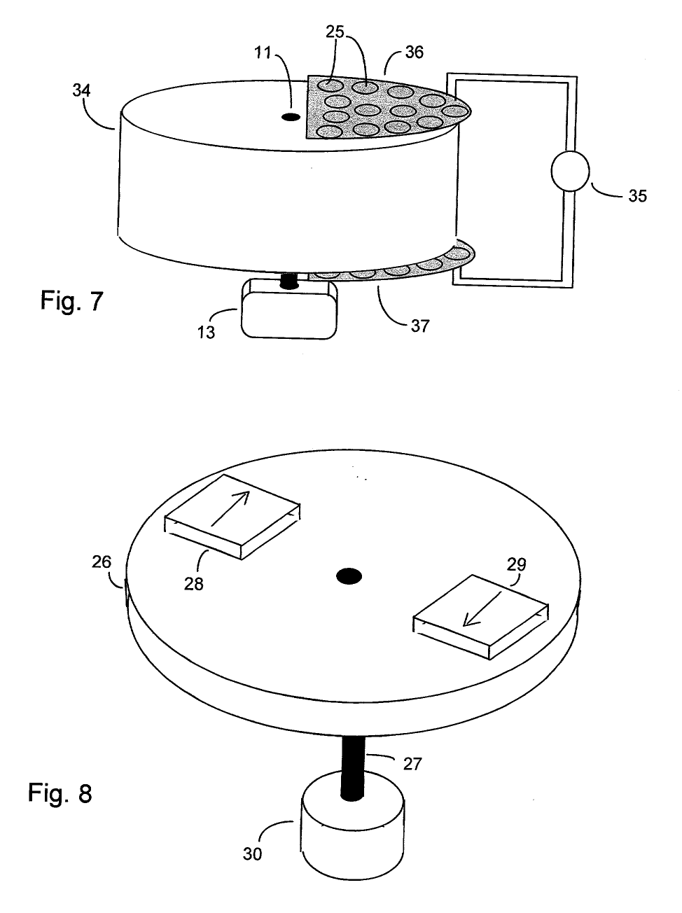

FIG. 7

FIG. 7 shows a disk with magnetic particles 34 that is mounted on shaft 11. Disk with magnetic particles 34 is made of an elastic material and includes many particles that experience a force when exposed to a magnetic field. The magnetic particles can be of any shape or size that would fit inside disk with magnetic particles 34. In order to feel a force from a magnetic field the particles would have to be ferromagnetic, paramagnetic or diamagnetic. Electric motor 13 turns shaft 11, which causes disk with magnetic particles 34 to rotate. An upper plate 36 is positioned above the right half of disk with magnetic particles 34. Upper plate 36 contains many examples of an electromagnet 25. A lower plate 37 is positioned below the right half of disk with magnetic particles 34 and also contains many examples of electromagnet 25. Electric energy for electromagnets 25 is supplied to upper plate 36 and lower plate 37 by electric power source 35.

As disk with magnetic particles 34 rotates, electromagnets 25 are caused to create a rapidly changing magnetic field that predominately passes into the right half of disk with magnetic particles 34. The magnetic field causes the magnetic particles to move within disk with magnetic particles 34. The movement of magnetic particles within disk with magnetic particles 34 causes the elastic material of disk with magnetic particles 34 to undergo stress. The stress causes a rapidly changing energy density for half of disk with magnetic particles 34, meaning there is a time averaged decrease in the mass of the right half of disk with magnetic particles 34. Because disk with magnetic particles 34 is rotating, the unbalanced centrifugal force will cause a propulsive force to the left for disk with magnetic particles 34.

Alternatively, electromagnets 25 could be replaced by permanent magnets. The permanent magnets could be oriented so that opposite poles would be adjacent to each other, causing quickly changing stress on the magnetic particles, in order to cause rapid changes in energy density for the rotating disk with magnetic particles 34.

Electromagnets 25, in FIG. 7, exert their greatest influence on the right of the upper and lower surfaces of disk with magnetic particles 34. Disk with magnetic particles 34 could be elongated into a cylinder as in FIGS. 1, 2, 3, 4, 5 and 6. Permanent or electromagnets could be placed near one half of such a rotating elastic cylinder with magnetic particles as is done in FIG. 5. Rotation through a rapidly changing magnetic field would cause a decrease in mass of half of the cylinder, which would be accompanied by a propulsive force.

All materials have some elastic properties. The magnetic material itself could also serve the elastic function. A disk substantially composed of a magnetic material that exhibits a changing energy density when exposed to a changing magnetic field could replace disk with magnetic particles 34.

An alternate embodiment of this invention would delete electromagnets 25 in FIG. 7. Electric power source 35 would place different and rapidly changing electric potentials on upper electrode 36 and lower electrode 37. Disk with magnetic particles 34 would then rotate through a rapidly changing electric field. Magnetic particles traveling through an electric field will experience a magnetic field causing the magnetic particles to move and put stress on the elastic material within disk with magnetic particles 34. The stress causes a changing energy density which reduces the mass of the right half of disk with magnetic particles 34, creating a propulsive force.

FIG. 8

FIG. 8 shows a method of generating electricity that employs the propulsive force produced by this invention. In FIG. 8, a first propulsion device 28 and a second propulsion device 29 are fixed to a turntable 26 that is attached to an electric generator shaft 27. Electric generator shaft 27 is connected to an electric generator 30. The internal structures of first propulsion device 28 and second propulsion device 29 are not shown. First propulsion device 28 and second propulsion device 29 could be propulsion devices as shown in FIGS. 2, 3, 4, 5, 6 or 7.

The arrows shown on first propulsion device 28 and second propulsion device 29 indicate the directions that first propulsion device 28 and second propulsion device 29 would be propelled if they were not attached to turntable 26. The propulsive force due to first propulsion device 28 and second propulsion device 29 causes turntable 26 and electric generator shaft 27 to rotate in a clockwise direction. The rotation of electric generator shaft 27 causes the generation of electricity by electric generator 30. The electricity generated by this invention can be used for any purpose that electricity produced by other means is used for.

First propulsion device 28 and second propulsion device 29 require electrical energy to operate. The electricity runs a motor that causes an elastic material to rotate and is the energy source for a means of changing the energy density of the elastic material. The electricity produced by electric generator 30 could be used to power first propulsion device 28 and second propulsion device 29.

It is not intended that the generation of electricity by this invention be limited to producing an electric current in a generator that uses a magnetic field. The rotation of turntable 26 could be used to produce an electric current by other means, such as by the activation of piezoelectric elements.

The rotation of turntable 26 could be used for purposes other than the generation of electricity. Electric generator shaft 27 could be replaced by a shaft connected to any type of machinery that requires rotation to operate. Alternatively, teeth cut into the outer edge of turntable 26 would make turntable 26 a driving gear that could drive any type of machinery that requires rotation to operate.

FIGS. 2, 3, 4, 5, 6, 7 and 8—Enhancements

The rotational motion found in FIG. 8 would cause turntable 26 to behave like a gyroscope. This isn't a problem for a stationary electric power source but it would be a problem if the power source of FIG. 8 were in a moving vehicle. Any turning motion of the vehicle that was not in the plane of turntable 26 would cause unwelcome forces on the vehicle. Turntable 26 could be mounted in gimbals so that, as the vehicle changes direction, turntable 26 would be free to turn on any axis.

All of the propulsion devices shown in FIGS. 2, 3, 4, 5, 6 and 7 engage in rapid rotation. If any of these devices provided the propulsive force for a vehicle, there would be gyroscopic forces that could have an adverse effect on the ability to control the vehicle's direction of travel. Mounting these propulsion devices in gimbals would limit the unwanted effects.

The propulsion devices described above made use of cylinders and a disk. The terms cylinder and disk can be used interchangeably. A disk is a flattened cylinder. The stress caused by mechanical and magnetic forces in FIGS. 2, 3, 4, 5, and 6 act perpendicularly to the long axis of the cylinder. Propulsive force would also be created if stress is appropriately induced at the top and bottom faces of the cylinders as is done in FIG. 7.

The stress used to produce a decrease in mass in FIGS. 2, 3, 4, 5, 6 and 7 is due to a magnetic field or physical pressure. Other means of causing stress in a rotating object are possible.

Conclusion, Ramifications, and Scope of Invention

While the above descriptions contain many specificities, these should not be construed as limitations on the invention, but rather as examples of embodiments of this invention. Other variations are possible. For example, the propulsive force provided by this invention need not cause motion of an object it is attached to but might work against another force, such as the force of gravity, to slow the motion of an object or to hold an object in place. While the descriptions of the figures included rotational motion of a physical object, any motion that is not in a straight line will create the centrifugal force that is necessary for propulsion in this invention. Also, the equation governing the decrease in mass due to rapid changes in energy density includes a term which leads to an increase or decrease in mass that comes about because of non-linear changes in energy density. To lessen this contribution to the mass of a propulsion device, changes in energy density could be made as nearly linear as possible.

Accordingly; the scope of the invention should not be determined by the embodiments illustrated, but by the appended claims and their legal equivalents.

I claim:

1. A device for producing a propulsive force, comprising;
a. a moving material, which changes its direction of travel,
b. an energy density altering means, which alters the energy density of said moving material in such a way that the mass of said moving material is altered in conjunction with changes in the direction of travel of said moving material whereby a propulsive force is created that acts on said moving material.

2. A device as in claim 1 in which said moving material is substantially elastic.

3. A device as in claim 1 in which said moving material is in substantially rotational motion.

4. A device as in claim 1 in which said energy density altering means is a stress causing means, whereby stress is applied to said moving material in such a way as to cause the mass of said moving material to be altered.

5. A device as in claim 4 in which said stress causing means is electromagnetic, whereby an electric field or a magnetic field or electromagnetic radiation causes an included piece to apply a stress to said moving material in such a way as to cause the mass of said moving material to be altered.

6. A device as in claim 4 in which said stress causing means is electromagnetic, whereby an electric field or a magnetic field or electromagnetic radiation causes to said moving material to experience a stress in such a way as to cause the mass of said moving material to be altered.

7. A device as in claim 1 in which said moving material is substantially cylindrical.

8. A device as in claim 1 in which said energy density altering means includes a substantially cylindrical piece that comes into physical contact with said moving material.

9. A device as in claim 1 in which said energy density altering means includes a piece that comes into physical contact with said moving material and is substantially composed of a material that is substantially less elastic than said moving material.

10. A device as in claim 1 including an electric generating means which converts kinetic energy derived from said propulsive force into electrical energy, which can be used to power any electrical device.

11. A device as in claim 10 in which the electrical energy produced is substantially the energy source for the operation of said energy density altering means.

12. A device as in claim 10 in which the electrical energy produced is substantially the energy source for causing the motion of said moving material.

13. A device as in claim 1 in which said propulsive force is employed to propel an object, which could be a vehicle.

14. A device as in claim 1 in which said propulsive force is employed to cause rotational motion.

15. A device as in claim 1 in which said propulsive force is employed in opposition to another force to alter the velocity of an object's motion.

16. A device as in claim 1 in which said moving material is mounted so as to allow substantially free rotation in a direction other than in the plane of rotation of said moving material.
